(19) United States
(12) Patent Application Publication
(10) Pub. No.: US 2013/0176399 A1
(43) Pub. Date: Jul. 11, 2013

(54) SYSTEM AND METHOD FOR CREATING A THREE-DIMENSIONAL IMAGE FILE

(71) Applicants: Dan Rothenbuhler, Boise, ID (US); Peter Majewicz, Boise, ID (US); Kenneth K. Smith, Boise, ID (US)

(72) Inventors: Dan Rothenbuhler, Boise, ID (US); Peter Majewicz, Boise, ID (US); Kenneth K. Smith, Boise, ID (US)

(73) Assignee: HEWLETT-PACKARD DEVELOPMENT COMPANY, L.P., Houston, TX (US)

(21) Appl. No.: 13/822,235

(22) PCT Filed: Nov. 29, 2010
(86) PCT No.: PCT/US2010/058218

§ 371 Date: Mar. 11, 2013

(51) Int. Cl. H04N 13/02

(52) U.S. Cl. CPC H04N 13/026
USPC 348/46

(57) ABSTRACT

A system includes a light source configured to illuminate a subject with a pattern, a first optical sensor configured to capture a first pattern image and a first object image of the subject, and a processing unit configured to determine elevation data of the subject based on the first pattern image and create a three-dimensional image file based on the first object image and the elevation data of the subject.

### BACKGROUND

Three-dimensional (“3D”) images are used in a variety of contexts such as e-commerce to display various objects (e.g., items for sale). For example, an online storefront displays a 3D rendering of an item that is sold. Such a 3D image file may permit a viewer to manipulate the item to view the item from a different angle, or to zoom in or zoom out on the item.

Three-dimensional image files can be generated by scanning a laser across the object and recording distance and angle values. These values are imported into a Computer Aided Design (“CAD”) program that generates a surface of the object. However, features such as colors and textures are not captured by laser scanners; to add such detail, extensive post-scan processing is required, for example mapping an image to the contours of the surface. The hardware and processing software required for laser scanning are both expensive and cumbersome.

### BRIEF DESCRIPTION OF THE DRAWINGS

For a detailed description of example embodiments of the invention, reference will now be made to the accompanying drawings in which:

FIG. 1a shows a system in accordance with various embodiments;

FIG. 1b shows a component of the system of FIG. 1a in accordance with various embodiments;

FIG. 1c shows a component of the system of FIG. 1a in accordance with various embodiments;

FIG. 2 shows an apparatus in accordance with various embodiments;

FIG. 3 shows a method flow chart in accordance with various embodiments; and

FIG. 4 shows another method flow chart in accordance with various embodiments.

### NOTATION AND NOMENCLATURE

In the following discussion and in the claims, the terms “including” and “comprising” are used in an open-ended fashion, and thus should be interpreted to mean “including, but not limited to . . . .” Also the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

In the following discussion and in the claims, the term “object image” means an image of a subject that captures the visual details of the subject such as colors or textures, similar to a conventional photograph. The term “pattern image” means an image of a subject that captures a projected pattern, such as an orthogonal grid, reflected by the subject from a light source. The projected pattern captured in the pattern image differs from the known pattern (e.g., an orthogonal grid) as projected onto a reference surface based on elevation of the subject relative to the reference surface. Thus, comparing the projected pattern captured in the pattern image to the known pattern enables the determination of elevation (i.e., 3D) data of the subject.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In accordance with various embodiments, a 3D scanner generates a 3D image file of a subject by determining elevation data of a subject, capturing an object image of the subject with an optical sensor and assigning an elevation to each pixel of the object image based on the elevation data of the subject. Pixel coordinates, image data (e.g., a color) and the determined elevation for the pixel may be stored in a suitable data structure, which is used to create the 3D image file.

The elevation data of a subject may be determined in various manners. For example, elevation data may be determined by measuring the difference between a known pattern projected onto the subject compared to the known pattern projected onto a reference surface (e.g., a flat surface positioned a known distance away from an optical sensor). For example, the pattern may be an orthogonal grid and in some embodiments, the spacing of the grid may be adjusted. A subject that is not flat, or is not the same as the reference surface, will cause the grid to be perceived in a pattern image as distorted, thus allowing elevation data of the subject to be determined. Elevation data is determined in this manner using a single optical sensor, however more than one optical sensor may be additionally employed. An example of determining elevation data of a subject based on a projected pattern is disclosed in U.S. Pat. No. 6,510,244 entitled “Method and System for Acquiring a Three-Dimensional Shape Description,” which is incorporated by reference herein.

Elevation data may alternately be determined through stereoscopic imaging. Multiple optical sensors, each having a coincident field of view of the subject, capture object images of the subject. The optical sensors are separated by a known distance and arranged in a known orientation. Identical features of the subject are identified in each image and the elevation of those features may be determined by measuring the parallax. Parallax is an apparent displacement of difference in the apparent position of an object viewed along two different lines of sight. Determining elevation data through stereoscopic imaging requires two or more optical sensors, unlike determining elevation data through the projection of a known pattern.

Furthermore, elevation data may be determined through a combination of projection of a known pattern and stereoscopic imaging. Such a combination offers increased levels of detail and accuracy. Each method may employ one or more light sources to illuminate the subject, project a grid pattern, or a combination of the two. Each method of determining elevation data offers various benefits and drawbacks; however, in accordance with various embodiments, any method of determining elevation data of a subject is intended to be included in the present disclosure.

However, elevation data on its own is insufficient to produce a 3D image file of a subject. Elevation data merely allows the surface of the subject to be determined, but without any detail as to the actual appearance (e.g., colors, textures) of the subject, which is helpful to produce a usable, informative 3D image file. Conventional methods of mapping a static image file onto a 3D surface are both time-consuming and expensive. In accordance with various embodiments, image data and elevation data are combined by assigning each pixel in a captured object image an elevation value (e.g., an elevation relative to a reference surface on which the subject sits) based on the determined elevation data. The resulting set of data, including image data and elevation data for each pixel, may be converted into a 3D image file format.

In accordance with various embodiments, further image processing or enhancement may be applied to the 3D image file to add distance cues, such as shading, variable color saturation, variable fading, or other techniques to give the illusion of depth. Additional 3D image files may be generated by moving the subject and capturing object images from a different orientation (e.g., turning the subject around, flipping the subject over). An image stitching algorithm, similar to those used to generate panoramic photos, may be applied to the various 3D image files of a subject to create a full 3D image file, or a 3D image file that permits viewing of the subject from any angle.

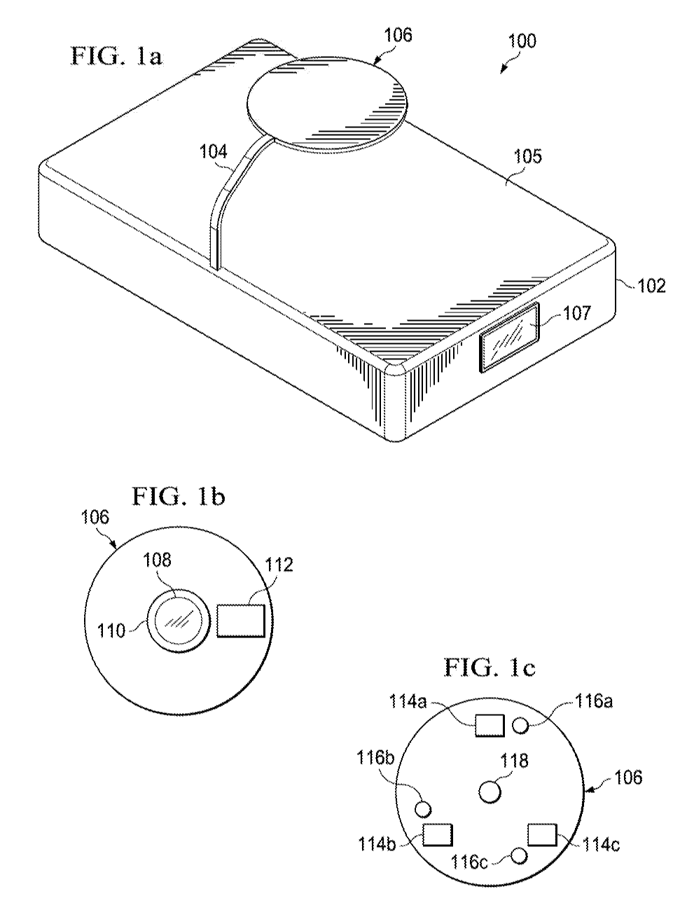

FIG. 1a shows a system 100 for creating 3D image files in accordance with various embodiments. The system includes a housing 102 coupled to an imaging device 106 by way of a support arm 104. The housing 102 includes a surface 105 on which a subject may be placed. The housing 102 may also house a processing unit or alternatively may couple to a processing unit of an external device. In some embodiments, the housing 102 may be a printer. The housing 102 further comprises a control panel 107, for example a touch-screen LCD.

FIG. 1b shows the imaging device 106 viewed from the underside (e.g., from the surface 105 facing upward). In the example of FIG. 1b, the imaging device 106 comprises a light source 108 and an optical sensor 112. The light source 108 may comprise a light-emitting diode (“LED”) or arrays of multiple LEDs; however, other light-producing elements may be similarly used Additionally, the light source 108 may further comprise a focusing mechanism 110 to direct the illumination of the light source 108. The focusing mechanism 110 may comprise a Fresnel lens, a back-reflector, diffuser or other focusing mechanism known by those one skilled in the art. The optical sensor 112 may be a complementary metal oxide semiconductor (“CMOS”) optical sensor. In alternate embodiments, the optical sensor 112 may be a charge coupled device (“CCD”) or any suitable device for image capture. The optical sensor 112 captures both pattern images and object images.

In accordance with various embodiments, the light source 108 is configured to project a pattern (e.g., a grid) onto the surface 105 or a subject on the surface 105, which may be subsequently captured by the optical sensor 112 in a pattern image. A variable size grid may be generated by projecting the illuminating light through, for example, an LCD screen, which may be a substitute for the focusing mechanism 110 or in addition to the focusing mechanism 110. Alternatively, other devices may be used to project the pattern, such as a diffraction grating, an interference pattern system, or a digital micromirror device. The embodiment of the imaging device 106 shown in FIG. 1b permits elevation data of the subject to be calculated based solely on the measurement of parallax because only one optical sensor is utilized. As discussed above, one optical sensor coupled with the projection of a known pattern is sufficient to determine elevation data of the subject. The light source 108 is additionally configured to illuminate a subject in a manner suitable for capturing an object image of the subject by the optical sensor 112.

FIG. 1c shows an alternate embodiment of the imaging device 106 also viewed from the underside. The alternate imaging device 106 comprises light sources 116a, 116b, 116c, 118 and optical sensors 114a, 114b, 114c. In this embodiment, the light source 118 is configured to project a pattern (e.g., a grid) onto the surface 105 and a subject and the light sources 116a, 116b, 116c are configured to illuminate the surface 105 and the subject while one or more of the optical sensors 114a, 114b, 114c capture an image of the surface 105 and the subject. The captured images using the light source 118 are pattern images and the captured images using the light sources 116a, 116b, 116c are object images. The embodiment of imaging device 106 shown in FIG. 1c permits elevation data of the subject to be calculated based on both stereoscopic imaging principles as well as measurement of a parallax based on the projection of a pattern, permitting a higher level of elevation data detail to be obtained.

The imaging device 106 may be configured in various ways, taking advantage of stereoscopic imaging, measuring a parallax based on projection of a pattern, or the combination of the two. The number of light sources and optical sensors may vary depending on the particular embodiment. Additionally, multiple object images and multiple pattern images may be captured by the optical sensors before creating a 3D image file.

A correspondence may be determined between object images of the same subject captured by different optical sensors. Each object image from a different optical sensor will have a slightly different view of the subject, and thus the correspondence between object images may be determined so that elevation data may be correctly mapped to the appropriate features of the subject. Correspondence between two images may be determined by, for example, determining whether one location in an object image from one optical sensor looks or seems like another location in an object image captured by a different optical sensor. Correspondence between two object images may alternatively be determined by, for example, identifying features in an object image from one optical sensor and determining whether the layout of a subset of features in an object image from a different optical sensor is similar.

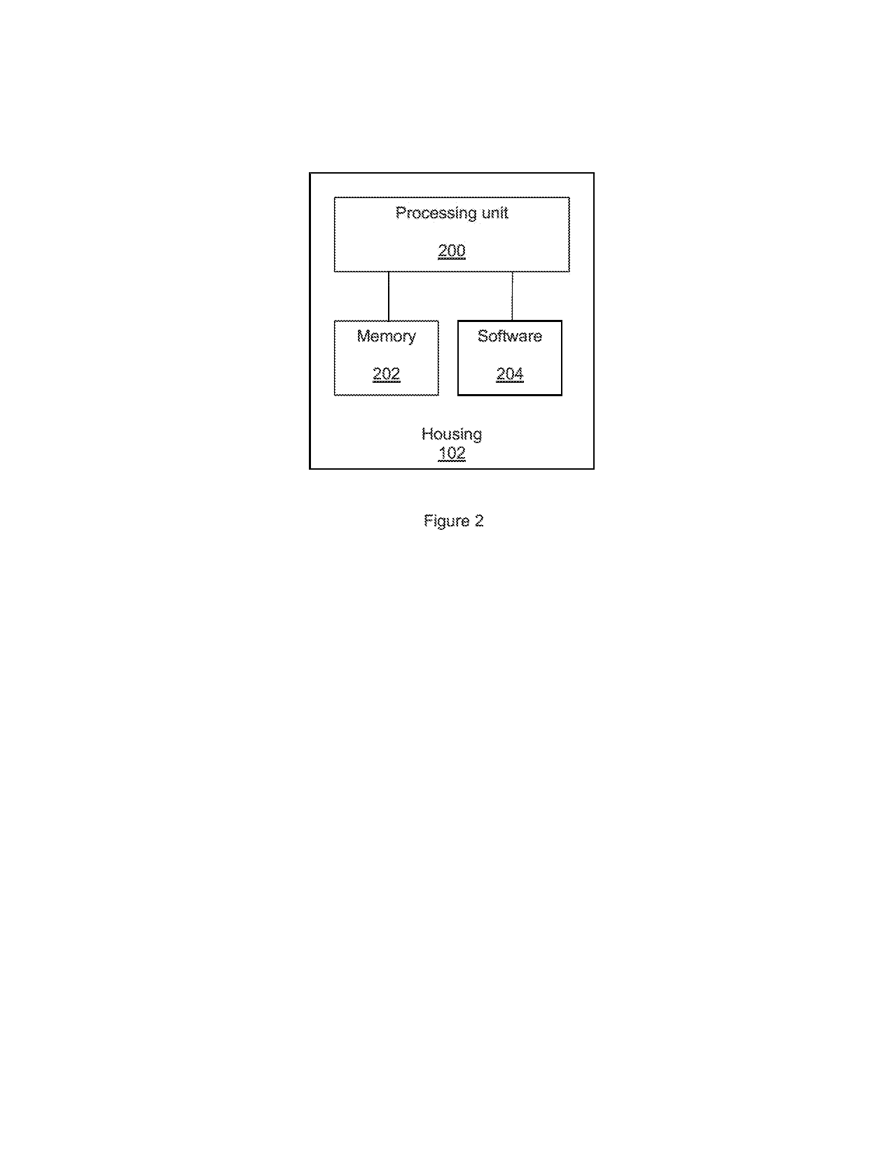

FIG. 2 shows an embodiment of housing 102 as comprising a processing unit 200 (e.g., a microprocessor) coupled to a memory 202 and software 204 in accordance with various embodiments. The software 204 may be stored in memory 202 or in another storage device. In alternate embodiments, the processing unit 200, memory 202 and software 204 may be coupled to the housing 102, but reside in a device external to the housing 102. The processing unit 200 is configured to create 3D image files by receiving and processing various images from one or more of the optical sensors 108, 114a, 114b, 114c, which are coupled to the housing 102 by way of the imaging device 106 and support arm 104 as shown in FIGS. 1a-c. A user may place a subject on the surface 105 to create a 3D image file of the subject. The system 100, which includes or is coupled to the processing unit 200, operates to create the 3D image file of the subject. Referring back to FIG. 1b for example, the light source 108 illuminates the subject with a pattern (e.g., a grid) and the optical sensor 112 captures a pattern image. The processing unit 200 determines elevation data of the subject based on the pattern image. For example, if the pattern is an orthogonal grid when projected onto a reference surface, the processing unit 200 determines differences in the captured pattern in the pattern image and the pattern when projected onto the reference surface. The processing unit 200 determines elevation data based on these differences.

The light source 108 also illuminates the subject in a manner suitable for photographing the subject (e.g., a flash, longer-duration lighting) and the optical sensor 112 captures an object image. In accordance with various embodiments, the elevation data represents pixel-by-pixel elevation values, each value corresponding to a pixel of the object image. Thus, the processing unit 200 associates or assigns each pixel of the object image with an elevation value. This association may be, for example, stored in any suitable data structure in memory 202. The following table is an exemplary data structure that associates each pixel coordinate with a color value and an elevation value:

| Pixel Coordinate | Pixel Color | Pixel Elevation |
|---|---|---|
| 50, 42 | Red | 1.4″ |
| 50, 43 | Green | 1.5″ |
| 50, 44 | Blue | 1.6″ |
| . . . | . . . | . . . |

The processing unit 200 converts the image data and the elevation data for the pixels into a 3D image file.

The processing unit 200 also may combine 3D image files of a subject, for example by stitching together 3D image files created from different viewing angles or orientations. The resulting 3D image file permits a user to view the subject from a greater variety of angles, which could not normally be achieved with a 3D image file created from a single viewing angle of the subject. In some embodiments, the resulting 3D image file is a full 3D image file, permitting a user to view the subject from any angle. Although discussed with respect to FIG. 1b, the processing unit 200 operates in a similar manner independent of the arrangement of light sources and optical sensors. In some embodiments, the software 204 is stored in a computer readable storage (e.g., RAM, HDD). Additionally, although the processor 200 has been disclosed as performing various operations, in alternate embodiments the processor 200 performs one or more of such operations through the execution of software 204.

Referring back to FIG. 1a, in an exemplary embodiment the control panel 107 is a touch-screen LCD that permits a user to view and manipulate a 3D image file. Manipulation includes rotating the viewing angle of the subject, zooming in or zooming out on the subject, and other similar image processing schemes. Once a user achieves a suitable viewing angle of the subject on the control panel 107, the user may print the view of the subject on the printer 102.

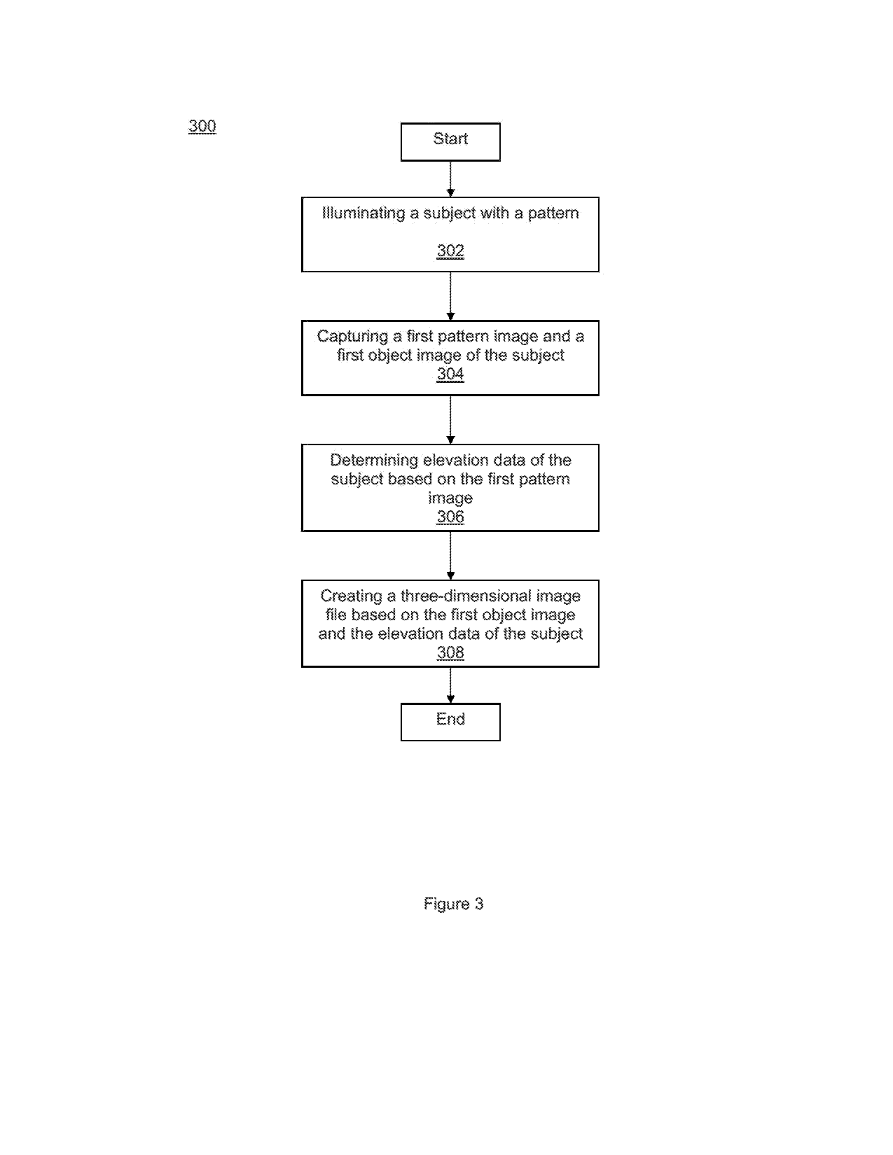

FIG. 3 shows a method 300 in accordance with various embodiments. The method 300 begins with illuminating a subject with a pattern (block 302). In an exemplary embodiment, a light source 108 illuminates the subject. The light source 108 may comprise a light-emitting diode (“LED”) or arrays of multiple LEDs; however, other light-producing elements may be similarly used. Additionally, the light source 108 may further comprise a focusing mechanism 110 to direct the illumination of the light source 108. In accordance with various embodiments, the light source 108 is configured to project a pattern (e.g., a grid) onto the surface 105 or a subject on the surface 105, which may be subsequently captured by the optical sensor 112 in a pattern image. A variable size grid may be generated by projecting the illuminating light through, for example, an LCD screen, which may be a substitute for the focusing mechanism 110 or in addition to the focusing mechanism 110.

The method 300 continues with capturing a first pattern image and a first object image of the subject (block 304). In an exemplary embodiment, an optical sensor 112 captures the pattern image and the object image. The optical sensor 112 is a complementary metal oxide semiconductor (“CMOS”) optical sensor. In alternate embodiments, the optical sensor 112 is a charge coupled device (“CCD”) or any suitable device for image capture. The optical sensor 112 captures both pattern images and object images, depending on the illumination of the subject.

The method 300 then continues with determining elevation data of the subject based on the first pattern image (block 306). In an exemplary embodiment, a processing unit 200 determines the elevation data of the subject. For example, where the pattern is an orthogonal grid when projected onto a reference surface, the processing unit 200 determines differences in the captured pattern in the pattern image and the pattern when projected onto the reference surface. The processing unit 200 determines elevation data based on these differences.

The method 300 further continues with creating a three-dimensional image file based on the first object image and the elevation data of the subject (block 308) and ends. In accordance with various embodiments, the elevation data represents pixel-by-pixel elevation values, each value corresponding to a pixel of the object image captured by the optical sensor 112. Thus, the processing unit 200 may associate or assign each pixel of the object image with an elevation value. This association may be, for example, stored in any suitable data structure in memory 202. The processing unit 200 converts the image data and the elevation data for the pixels into a 3D image file.

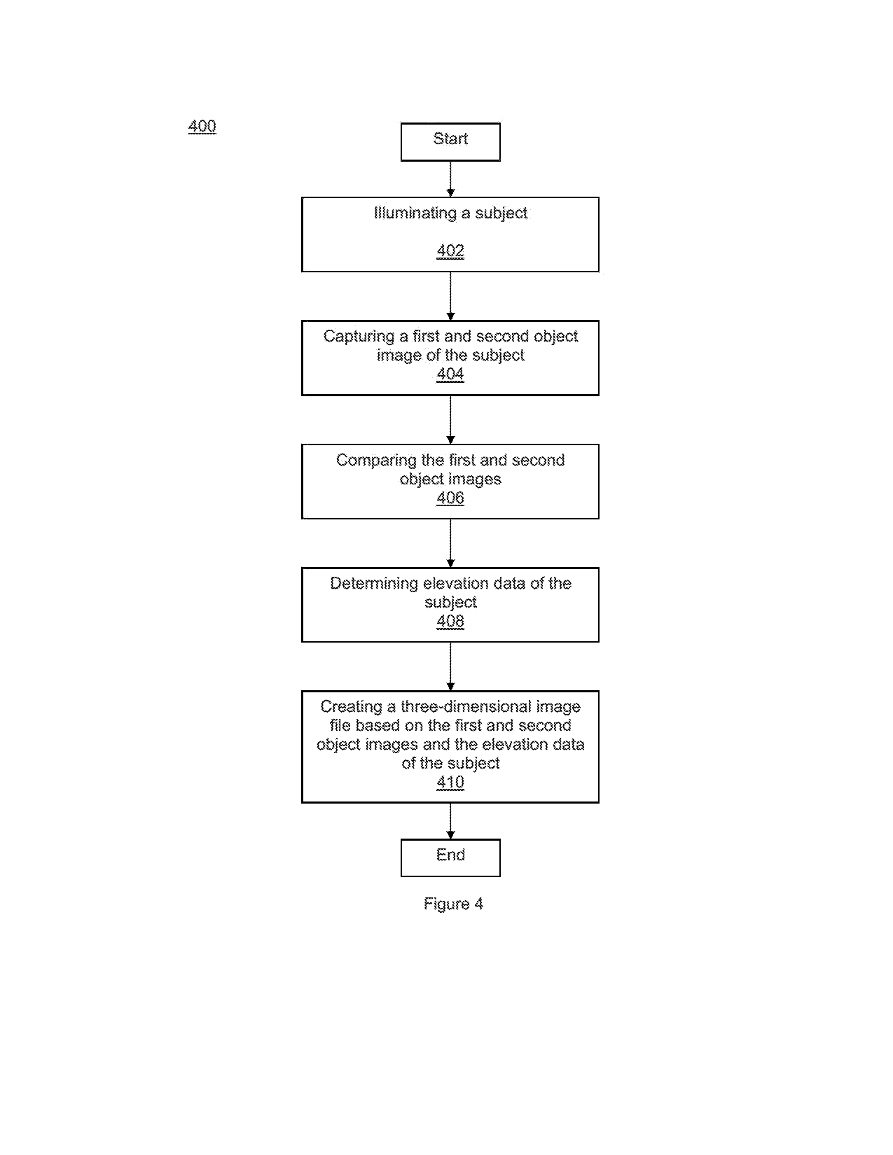

FIG. 4 shows another method 400 in accordance with various embodiments. The method begins with illuminating a subject (block 402). In an exemplary embodiment, a light source 108, 116a, 116b, 116c illuminates the subject, similar to above. However, the light source 108, 116a, 116b, 116c does not need to be capable of illuminating the subject with a pattern. The method continues with capturing a first and second object image of the subject (block 404). In accordance with various embodiments, each of the object images is captured by a different optical sensor (e.g., optical sensors 114a, 114b, 114c) each having a coincident field of view of the subject. In alternate embodiments, more than two object images may be captured by two or more optical sensors.

The method 400 then continues with comparing the first and second object images (block 406) and determining elevation data of the subject (block 408). The optical sensors 114a, 114b, 114c are separated by a known distance and arranged in a known orientation. In accordance with various embodiments, the processing unit 200 may identify identical features of the subject in each object image and determine the elevation of those features by measuring the parallax. The processing unit 200 determines elevation data of the subject between the identical features based on the proximity to the identical feature.

The method 400 further continues with creating a three-dimensional image file based on the first and second object images and the elevation data of the subject (block 410) and ends. As discussed above with respect to FIG. 3, the elevation data represents pixel-by-pixel elevation values, each value corresponding to a pixel of the object images captured by the optical sensors 114a, 114b, 114c. Thus, the processing unit 200 may associate or assign each pixel of the object images with an elevation value. This association may be, for example, stored in any suitable data structure in memory 202. The processing unit 200 converts the image data and the elevation data for the pixels into a 3D image file.

The above discussion is meant to be illustrative of the principles and of various embodiments of the present invention. Numerous variations and modifications will become apparent to those skilled in the art once the above disclosure is fully appreciated. For example, the number of optical sensors and light sources may vary, and additional images may be captured before creating a 3D image file. Furthermore, each 3D image file may undergo further processing steps before being finalized and output to the user. It is intended that the following claims be interpreted to embrace all such variations and modifications.

What is claimed is:

1. A system comprising:
a light source configured to illuminate a subject with a pattern;
a first optical sensor configured to capture a first pattern image and a first object image of the subject; and
a processing unit configured to:
determine elevation data of the subject based on the first pattern image; and
create a three-dimensional image file based on the first object image and the elevation data of the subject.

2. The system of claim 1 further comprising:
a control panel configured to allow a user to manipulate the three-dimensional image file; and
a printer configured to print the manipulated image file.

3. The system of claim 1 further comprising:
a second optical sensor configured to capture a second pattern image and a second object image of the subject;
wherein the processing unit is configured to:
determine elevation data of the subject based on the first and second pattern images and a comparison of the first and second object images; and
create a three-dimensional image file based on the first and second object images and the elevation data of the subject.

4. The system of claim 1 wherein the processor determines elevation data based on the difference between the pattern projected onto a reference surface and the pattern image.

5. The system of claim 1 wherein the processor is further configured to enhance the three-dimensional image file to add distance cues.

6. A method comprising:
illuminating, by a light source, a subject with a pattern;
capturing, by a first optical sensor, a first pattern image and a first object image of the subject;
determining elevation data of the subject based on the first pattern image;
creating a three-dimensional image file based on the first object image and the elevation data of the subject.

7. The method of claim 6 wherein determining elevation data further comprises determining elevation data based on the difference between the pattern projected onto a reference surface and the pattern image.

8. The method of claim 6 wherein creating a three-dimensional image file further comprises mapping the first object image into a three-dimensional space based on the elevation data of the subject.

9. The method of claim 6 further comprising:
capturing, by a second optical sensor, a second pattern image and a second object image of the subject;
determining elevation data of the subject based on the first and second pattern images and a comparison of the first and second object images;
creating a three-dimensional image file based on the first and second object images and the elevation data of the subject.

10. The method of claim 6 further comprising:
capturing, by the first optical sensor, an additional pattern image and an additional object image of the subject;
determining additional elevation data of the subject based on the additional pattern image;
creating an additional three-dimensional image file based on the additional object image and the elevation data of the subject; and
combining the three-dimensional image file and the additional three-dimensional image file to create a full three-dimensional image file;
wherein the orientation of the subject is different in the additional pattern and object images than in the first pattern and object images.

11. The method of claim 6 further comprising enhancing the three-dimensional image file to add distance cues.

12. A method comprising:
illuminating, by a light source, a subject;
capturing, by a first optical sensor, a first object image of the subject;
capturing, by a second optical sensor, a second object image of the subject;
comparing the first and second object images;
determining, based on the comparison, elevation data of the subject; and
creating a three-dimensional image file based on the first and second object images and the elevation data of the subject.

13. The method of claim 12 wherein creating a three-dimensional image file further comprises mapping the first and second object images into a three-dimensional space based on the elevation data of the subject.

14. The method of claim 12 further comprising:
capturing, by the first optical sensor, a third object image;
capturing, by the second optical sensor, a fourth object image;
comparing the third and fourth object images;
determining, based on the comparison, additional elevation data of the subject;
creating an additional three-dimensional image file based on the third and fourth object images and the elevation data of the subject; and
combining the three-dimensional image file and the additional three-dimensional image file to create a full three-dimensional image file
wherein the orientation of the subject is different in the third and fourth object images than in the first and second object images.

15. The method of claim 12 further comprising enhancing the three-dimensional image file to add distance cues.
